(19) United States
(12) Patent Application Publication
(10) Pub. No.: US 2026/0112387 A1
(43) Pub. Date: Apr. 23, 2026

(54) SYSTEM AND A METHOD FOR AUDIO ANALYSIS

(71) Applicant: ONIBER SOFTWARE PRIVATE LIMITED, Pune (IN)

(72) Inventors: Raghu Sesha Iyengar, Bangalore (IN); Ankush Tiwari, Pune (IN); Abhijeet Zilpelwar, Pune (IN); Prabhakaran Nandkumar, Bengaluru (IN); Anant Dhok, Amravati (IN)

(21) Appl. No.: 19/365,271

(22) Filed: Oct. 22, 2025

(30) Foreign Application Priority Data
Oct. 22, 2024 (IN) 202421080381

(51) Int. Cl. G10L 25/69; G10L 25/30

(52) U.S. Cl. CPC G10L 25/69; G10L 25/30

(57) ABSTRACT

The present subject matter relates to a system (100) and a method (300) for audio analysis. The system (100) is configured to receive an input audio file. Further, the system (100) is configured to pre-process the received input audio file and split the pre-processed input audio file into one or more chunks. Furthermore, the system (100) is configured to extract one or features corresponding to each chunk from the one or more chunks. Moreover, the system (100) generates embedding of each chunk from the one or more chunks based on the one or more features. Additionally, the system (100) classifies each chunk based on the generated embeddings, determining whether each chunk is real or synthetic. The system (100) provide information of each classified chunk to the user as either the real chunk or the synthetic chunk. The system enhances the ability to identify synthetic portions in artificially manipulated audio content.

### CROSS-REFERENCE TO RELATED APPLICATIONS AND PRIORITY

The present application claim priority from Indian Patent Application No. 202421080381 filed on Oct. 22, 2024.

### FIELD OF INVENTION

The presently disclosed embodiments are related, in general, to the field of digital media analysis. More particularly, the present disclosure relates to a system and a method for audio analysis to identify synthetic portions within an audio data.

### BACKGROUND OF THE INVENTION

This section is intended to introduce the reader to various aspects of art, which may be related to various aspects of the present disclosure that are described or claimed below. This discussion is believed to be helpful in providing the reader with background information to facilitate a better understanding of the various aspects of the present disclosure. Accordingly, it should be understood that these statements in this background section are to be read in this light, and not as admissions of prior art. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

In today's world, where artificial intelligence (AI) is rapidly advancing, the creation and manipulation of multimedia content, including audio files, have become increasingly state of the art. AI generated audio, such as synthetic voices and deepfakes, can mimic human speech with exceptional realism, making it challenging for conventional systems to detect such manipulations. The problem lies in the limitations of conventional systems, which were designed to process only basic audio features, thereby lacking the capability to identify manipulated or artificial audio content.

In a world where AI-generated audio can be used to spread misinformation, manipulate public opinion, impersonation, and even incite social unrest, the inability to distinct between real and synthetic audio has serious implications for fields like journalism, security, and public trust. Moreover, detecting synthetic portions of audio within a larger file is a complex problem that conventional systems are unable to handle, leading to misclassifications and inaccurate results.

One of the important issue in the conventional system is their limited ability to process large and complex audio recordings. Many conventional systems are designed to handle audio as a whole, rather than breaking it down into smaller, more manageable segments. This makes it difficult to detect subtle manipulations, especially when artificial audio is embedded within an otherwise authentic recording. As a result, these systems often overlook small but important details, leading to inaccurate analysis.

Analysing entire audio recordings rather than breaking them into smaller segments poses significant challenges, primarily due to the increased demand on memory and processing power. This comprehensive analysis often leads to longer processing times and higher computational costs, making it impractical for real-time applications. Additionally, users are unable to select specific portions of audio for targeted analysis, limiting their ability to focus on relevant segments that may contain critical information or potential manipulations. This lack of detail makes audio analysis systems less effective, as users cannot prioritize specific portions of the audio to quickly and accurately detect whether it is real or fake.

Another important challenge is the inefficiency in extracting relevant audio characteristics. Conventional systems often use basic algorithms that cannot capture the intricate characteristics of sound necessary for identifying synthetic audio. These systems are typically unable to detect the intricate modifications in tone, rhythm, and pitch that occur in synthetic audio, resulting in frequent misclassifications. Moreover, with AI continuously evolving, the systems used to generate synthetic audio have become more seamless, making detection even harder.

In light of the above stated discussion, there exists a need of an improved system and method for audio analysis to overcome at least one of the above stated disadvantages.

Further limitations and disadvantages of conventional and traditional approaches will become apparent to one of skill in the art, through the comparison of described systems with some aspects of the present disclosure, as set forth in the remainder of the present application and with reference to the drawings.

### SUMMARY OF THE INVENTION

Before the present system and device and its components are summarized, it is to be understood that this disclosure is not limited to the system and its arrangement as described, as there can be multiple possible embodiments which are not expressly illustrated in the present disclosure. The present disclosure overcomes one or more shortcomings of the prior art and provides additional advantages discussed throughout the present disclosure. Additional features and advantages are realized through the techniques of the present disclosure. It is also to be understood that the terminology used in the description is for the purpose of describing the versions or embodiments only and is not intended to limit the scope of the present application. This summary is not intended to identify essential features of the claimed subject matter nor is it intended for use in detecting or limiting the scope of the claimed subject matter.

According to embodiments illustrated in a present disclosure, a system for audio analysis is disclosed. In one implementation of the present disclosure, the system may involve a processor and a memory. The memory is communicatively coupled to the processor. Further, the memory is configured to store processor executable instructions, which, on execution, may cause the processor to receive an input audio file. Further, the processor may be configured to pre-process the received input audio file. Further, the processor may be configured to split the pre-processed input audio file into one or more chunks. Further, the processor may be configured to extract one or more features corresponding to each chunk from the one or more chunks. Furthermore, the processor may be configured to generate embeddings of each chunk from the one or more chunks, using a transformer encoder model based on the extracted one or more features. Furthermore, the processor may be configured to classify, via a classification model, each chunk from the one or more chunks, to either a real chunk or a synthetic chunk based on the generated embeddings. Additionally, the processor may be configured to provide each chunk from the one or more chunks with an indication of either the real chunk or the synthetic chunk.

According to embodiments illustrated herein, there is provided a method for audio analysis. In one implementation of the present disclosure, the method may involve various steps performed by the processor. The method may involve a step of receiving via the processor, the input audio file. Further, the method may involve a step of pre-processing, via the processor, the received input audio file. Furthermore, the method may involve a step of splitting, via the processor, the pre-processed input audio file into the one or more chunks. Furthermore, the method may involve a step of extracting, via the processor, the one or more features corresponding to each chunk from the one or more chunks. Furthermore, the method may involve a step of generating embeddings of each chunk from the one or more chunks, using the transformer encoder model based on the extracted one or more features. Furthermore, the method may involve a step of classifying, via the processor coupled to the classification model, each chunk from the one or more chunks, to either the real chunk or the synthetic chunk based on the generated embeddings. Additionally, the method may involve a step of providing each chunk from the one or more chunks with the indication of either the real chunk or the synthetic chunk.

According to embodiments illustrated herein, there is provided a non-transitory computer-readable storage medium having stored thereon, a set of computer-executable instructions causing a computer comprising one or more processors to perform various steps. The steps may involve receiving the input audio file. Further, the steps may involve pre-processing the received input audio file. Furthermore, the steps may involve splitting the pre-processed input audio file into the one or more chunks. Furthermore, the steps may involve extracting the one or more features corresponding to each chunk from the one or more chunks. Furthermore, the steps may involve generating embeddings of each chunk from the one or more chunks, using the transformer encoder model based on the extracted one or more features. Furthermore, the steps may involve classifying, via the classification model, each chunk from the one or more chunks, to either the real chunk or the synthetic chunk based on the generated embeddings. Additionally, the steps may involve providing each chunk from the one or more chunks with the indication of either the real chunk or the synthetic chunk.

The foregoing summary is illustrative only and is not intended to be in any way limiting. In addition to the illustrative aspects, embodiments, examples, and features described above, further aspects, embodiments, and features will become apparent by reference to the drawings and the following detailed description.

### BRIEF DESCRIPTION OF DRAWINGS

The accompanying drawings illustrate the various embodiments of systems, methods, and other aspects of the disclosure. Any person with ordinary skills in art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements.

The detailed description is described with reference to the accompanying figures. In the figures, same numbers are used throughout the drawings to refer like features and components. Embodiments of a present disclosure will now be described, with reference to the following diagrams below wherein:

FIG. 1 illustrates a block diagram describing a system (100) for audio analysis, in accordance with at least one embodiment of the present disclosure.

FIG. 2 illustrates a block diagram showing an overview of various components of an application server (101) configured for audio analysis, in accordance with at least one embodiment of the present disclosure.

FIG. 3 illustrates a flowchart describing a method (300) for audio analysis, in accordance with at least one embodiment of the present disclosure; and

FIG. 4 illustrates a block diagram (400) of an exemplary computer system (401) for implementing embodiments consistent with the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION OF THE INVENTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the features, structures or characteristics may be combined in any suitable manner in one or more embodiments.

The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items. It must also be noted that, the singular forms “a,” “an,” and “the” include plural references unless the context clearly dictates otherwise. Although any methods similar or equivalent to those described herein can be used in the practice or testing of embodiments of the present disclosure, the exemplary methods are described. The disclosed embodiments are merely exemplary of the disclosure, which may be embodied in various forms.

The terminology “synthetic”, “artificial”, “fake”, and “deepfake” has the same meaning and are used alternatively throughout the specification. Further, the terminology “chunk”, “segment”, and “portion” has the same meaning and are used alternatively throughout the specification. Further, the terminology “identify” and “detect” has the same meaning and are used alternatively throughout the specification. Furthermore, the terminology “user” and “users” has the same meaning and are used alternatively throughout the specification.

The present disclosure relates to a system for audio analysis to identify synthetic portions within an audio file. The system comprises a processor and a memory communicatively coupled to the processor, and the memory is configured to store processor-executable instructions which, on execution, may cause the processor to receive the input audio file. Further, the system may pre-process the received input audio file. Furthermore, the system may split the pre-processed input audio file into one or more chunks. Further, the system may extract one or more features corresponding to each chunk from the one or more chunks. Furthermore, system may generate embeddings of each chunk from the one or more chunks, using a transformer encoder model based on the extracted one or more features. Furthermore, the system may classify, via a classification model, each chunk from the one or more chunks, to either a real chunk or a synthetic chunk based on the generated embeddings. Moreover, the system may provide each chunk from the one or more chunks with an indication of either the real chunk or the synthetic chunk.

To address the problems of conventional systems, the disclosed system integrates advanced processing and classification techniques for more accurate detection of real chunk and the synthetic chunk, in the audio file. Unlike conventional methods that struggle to detect subtle manipulations in audio, this system utilizes the transformer encoder model to generate embeddings of the audio chunks based on the extracted one or more features. These embeddings allow the classification model to distinguish between real and synthetic portions with greater accuracy. The system also offers a user-friendly interface, making it easy for users to analyse audio files and view results, ensuring a reliable and efficient solution for identifying manipulated audio content.

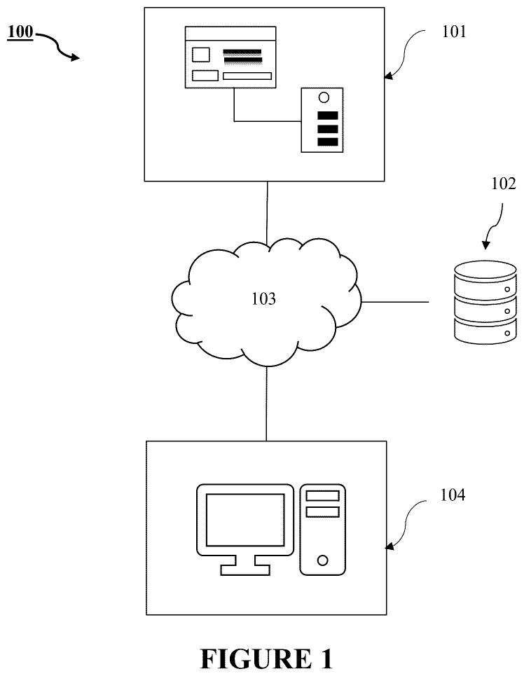

Referring to FIG. 1 is a block diagram that illustrates a system (100) for audio analysis, in accordance with at least one embodiment of the present disclosure. The system (100) typically includes an application server (101), a database server (102), a communication network (103), and a user computing device (104). The application server (101), the database server (102), and the user computing device (104) are typically communicatively coupled with each other via the communication network (103). In an embodiment, the application server (101) may communicate with the database server (102), and the user computing device (104) using one or more protocols such as, but not limited to, Hypertext Transfer Protocol (HTTP), Transmission Control Protocol/Internet Protocol (TCP/IP), Wireless Application Protocol (WAP), RF mesh, Bluetooth Low Energy (BLE), and the like, to communicate with one another.

In an embodiment, the database server (102) may refer to a computing device that may be configured to store the received input audio files, the pre-processed input audio files, the extracted one or more features and the generated embeddings corresponding to each chunk from the one or more chunks, classification scores, and the classified one or more chunks. In an embodiment, the database server (102) may include a special purpose operating system specifically configured to perform one or more database operations on the received input audio file. In an embodiment, the database server (102) may include one or more instructions specifically for storing the training data used to enhance the performance of the system's models including a feeder neural network model, the transformer encoder model, and the classification model. Examples of database operations may include, but are not limited to, storing, retrieving, comparing, and updating data related to the processing of the audio. In an embodiment, the database server (102) may include hardware that may be configured to perform the processing of the audio. In an embodiment, the database server (102) may be realized through various technologies such as, but not limited to, Microsoft® SQL Server, Oracle®, IBM DB2®, Microsoft Access®, PostgreSQL®, MySQL®, SQLite®, distributed database technology and the like. In an embodiment, the database server (102) may be configured to utilize the application server (101) for storage and retrieval of data used for audio analysis to identify synthetic portions within the audio file.

A person with ordinary skills in art will understand that the scope of the disclosure is not limited to the database server (102) as a separate entity. In an embodiment, the functionalities of the database server (102) can be integrated into the application server (101) or into the user computing device (104).

In an embodiment, the application server (101) may refer to a computing device or a software framework hosting an application or a software service. In an embodiment, the application server (101) may be implemented to execute procedures such as, but not limited to, programs, routines, or scripts stored in one or more memories for supporting the hosted application or the software service. In an embodiment, the hosted application or the software service may be configured to perform one or more specific operations. The application server (101) may be realized through various types of application servers such as, but are not limited to, a Java application server, a .NET framework application server, a Base4 application server, a PHP framework application server, or any other application server framework.

In another embodiment, the application server (101) may be configured to utilize the database server (102) and the user computing device (104), in conjunction, for audio analysis. In an implementation, the application server (101) is configured for an automated processing of the audio in various formats, such as MP3, WAV, and AAC, to identify synthetic portions within the input audio file by performing various operations including pre-processing, splitting of the pre-processed input audio file, and extracting of the one or more features. Further, the application server (101) may provide the one or more features corresponding to each chunk from the one or more chunks to both the feeder neural network model and the transformer encoder model. Each chunk is further classified as either the real chunk or the synthetic chunk.

In yet another embodiment, the application server (101) may be configured to receive the input audio file.

In yet another embodiment, the application server (101) may be configured to pre-process the received input audio file.

In yet another embodiment, the application server (101) may be configured to split the pre-processed input audio file into the one or more chunks.

In yet another embodiment, the application server (101) may be configured to extract the one or more features corresponding to each chunk from the one or more chunks.

In yet another embodiment, the application server (101) may be configured to generate embeddings of each chunk from the one or more chunks, using the transformer encoder model based on the extracted one or more features.

In yet another embodiment, the application server (101) may be configured to classify, via the classification model, each chunk from the one or more chunks, to either the real chunk or the synthetic chunk based on the generated embeddings.

In yet another embodiment, the application server (101) may be configured to provide each chunk from the one or more chunks with an indication of either the real chunk or the synthetic chunk.

In an embodiment, the communication network (103) may correspond to a communication medium through which the application server (101), the database server (102), and the user computing device (104) may communicate with each other. Such communication may be performed in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), Wireless Application Protocol (WAP), File Transfer Protocol (FTP), ZigBee, EDGE, infrared IR), IEEE 802.11, 802.16, 2G, 3G, 4G, 5G, 6G, 7G, cellular communication protocols, and/or Bluetooth (BT) communication protocols. The communication network (103) may either be a dedicated network or a shared network. Further, the communication network (103) may include a variety of network devices, including routers, bridges, servers, computing devices, storage devices, and the like. The communication network (103) may include, but is not limited to, the Internet, intranet, a cloud network, a Wireless Fidelity (Wi-Fi) network, a Wireless Local Area Network (WLAN), a Local Area Network (LAN), a cable network, the wireless network, a telephone network (e.g., Analog, Digital, POTS, PSTN, ISDN, xDSL), a telephone line (POTS), a Metropolitan Area Network (MAN), an electronic positioning network, an X.25 network, an optical network (e.g., PON), a satellite network (e.g., VSAT), a packet-switched network, a circuit-switched network, a public network, a private network, and/or other wired or wireless communications network configured to carry data.

In an embodiment, the user computing device (104) may comprise one or more processors and one or more memory. The one or more memories may include computer readable code that may be executable by one or more processors to perform specific operations. In an embodiment, the user computing device (104) may present a web user interface to transmit the user input to the application server (101). Example web user interfaces presented on the one or more portable devices to display each chunk from the one or more chunks with the indication of either the real chunk or the synthetic chunk to the user to facilitate interaction within the system (100). Examples of the user computing devices may include, but are not limited to, a personal computer, a laptop, a personal digital assistant (PDA), a mobile device, a tablet, or any other computing device.

The system (100) can be implemented using hardware, software, or a combination of both, which includes using where suitable, one or more computer programs, mobile applications, or “apps” by deploying either on-premises over the corresponding computing terminals or virtually over cloud infrastructure. The system (100) may include various micro-services or groups of independent computer programs which can act independently in collaboration with other micro-services. The system (100) may also interact with a third-party or external computer system. Internally, the system (100) may be the central processor of all requests for transactions by the various actors or users of the system. A critical attribute of the system (100) is that it can leverage the neural network model and process various formats of audio for further analysis by extracting the one or more features corresponding to each chunk from the one or more chunks and classifying the features into the real chunk and the synthetic chunk. In a specific embodiment, the system (100) is implemented for audio analysis.

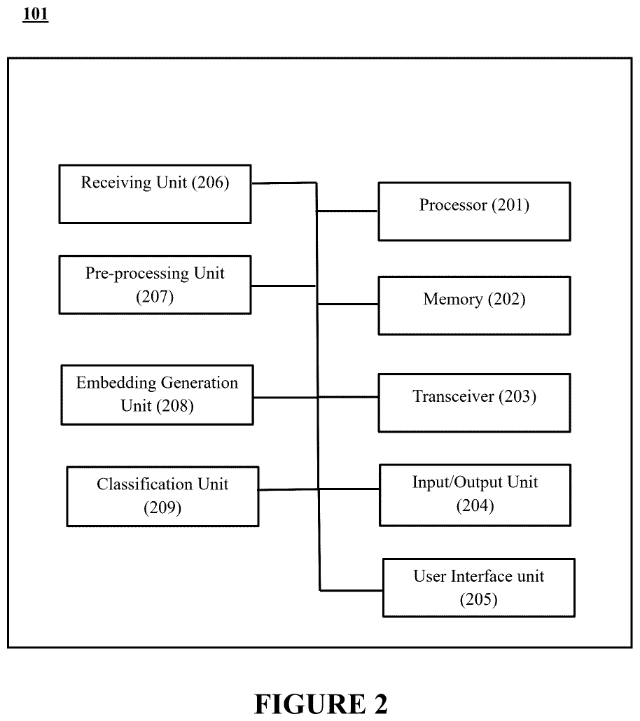

Now referring to FIG. 2, illustrates a block diagram showing an overview of various components of the application server (101) configured for audio analysis, in accordance with at least one embodiment of the present disclosure. FIG. 2 is explained in conjunction with elements from FIG. 1. In an embodiment, the application server (101) includes a processor (201), a memory (202), a transceiver (203), an input/output unit (204), a user interface unit (205), a receiving unit (206), a pre-processing unit (207), an embedding generation unit (208), and a classification unit (209). The processor (201) may be communicatively coupled to the memory (202), the transceiver (203), the input/output unit (204), the user interface unit (205), the receiving unit (206), the pre-processing unit (207), the embedding generation unit (208), and the classification unit (209). The transceiver (203) may be communicatively coupled to the communication network (103) of the system (100).

In an embodiment, the application server (101) may be configured to receive the input audio file for audio analysis. Further, the application server (101) may be configured to pre-process the received input audio file. Further, the application server (101) may be configured to split the pre-processed input audio file into the one or more chunks. Further, the application server (101) may be configured to extract the one or more features corresponding to each chunk from the one or more chunks. Furthermore, the application server (101) may be configured to generate embeddings of each chunk from the one or more chunks, using the transformer encoder model based on the extracted one or more features Furthermore, the application server (101) may be configured to classify, via the classification model, each chunk from the one or more chunks, to either the real chunk or the synthetic chunk based on the generated embeddings. Moreover, the application server (101) may be configured to provide each chunk from the one or more chunks with the indication of either the real chunk or the synthetic chunk.

The processor (201) comprises suitable logic, circuitry, interfaces, and/or code that may be configured to execute a set of instructions stored in the memory (202), and may be implemented based on several processor technologies known in the art. The processor (201) works in coordination with the memory (202), the transceiver (203), the input/output unit (204), the user interface unit (205), the receiving unit (206), the pre-processing unit (207), the embedding generation unit (208), and the classification unit (209) for audio analysis. Examples of the processor (201) include, but not limited to, a standard microprocessor, microcontroller, central processing unit (CPU), an X86-based processor, a Reduced Instruction Set Computing (RISC) processor, an Application-Specific Integrated Circuit (ASIC) processor, and a Complex Instruction Set Computing (CISC) processor, distributed or cloud processing unit, state machines, logic circuitries, and/or any devices that manipulate signals based on operational instructions and/or other processing logic that accommodates the requirements of the present invention.

The memory (202) comprises suitable logic, circuitry, interfaces, and/or code that may be configured to store the set of instructions, which are executed by the processor (201). Preferably, the memory (202) is configured to store one or more programs, routines, or scripts that are executed in coordination with the processor (201). Additionally, the memory (202) may include any computer-readable medium or computer program product known in the art including, for example, volatile memory, such as static random-access memory (SRAM) and dynamic random-access memory (DRAM), and/or non-volatile memory, such as read-only memory (ROM), erasable programmable ROM, a Hard Disk Drive (HDD), flash memories, Secure Digital (SD) card, Solid State Disks (SSD), optical disks, magnetic tapes, memory cards, virtual memory and distributed cloud storage. The memory (202) may be removable, non-removable, or a combination thereof. Further, the memory (202) may include routines, programs, objects, components, data structures, etc., which perform particular tasks or implement particular abstract data types. The memory (202) may include programs or coded instructions that supplement the applications and functions of the system (100). In one embodiment, the memory (202), amongst other things, serves as a repository for storing data processed, received, and generated by one or more of the programs or the coded instructions. In yet another embodiment, the memory (202) may be managed under a federated structure that enables the adaptability and responsiveness of the application server (101).

The transceiver (203) comprises suitable logic, circuitry, interfaces, and/or code that may be configured to receive, process or transmit information, data or signals, which are stored by the memory (202) and executed by the processor (201). The transceiver (203) is preferably configured to receive, process or transmit, one or more programs, routines, or scripts that are executed in coordination with the processor (201). The transceiver (203) is preferably communicatively coupled to the communication network (103) of the system (100) for communicating all the information, data, signals, programs, routines or scripts through the communication network (103).

The transceiver (203) may implement one or more known technologies to support wired or wireless communication with the communication network (103). In an embodiment, the transceiver (203) may include but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. Also, the transceiver (203) may communicate via wireless communication with networks, such as the Internet, an Intranet and/or a wireless network, such as a cellular telephone network, a wireless local area network (LAN) and/or a metropolitan area network (MAN). Accordingly, the wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The input/output (I/O) unit (204) comprises suitable logic, circuitry, interfaces, and/or code that may be configured to receive or present information. The input/output unit (204) comprises various input and output devices that are configured to communicate with the processor (201). Examples of the input devices include but are not limited to, a keyboard, a mouse, a joystick, a touch screen, a microphone, a camera, and/or a docking station. Examples of the output devices include, but are not limited to, a display screen and/or a speaker. The I/O unit (204) may include a variety of software and hardware interfaces, for example, a web interface, a graphical user interface, and the like. The I/O unit (204) may allow the system (100) to interact with the user directly or through the user computing devices (104). Further, the I/O unit (204) may enable the system (100) to communicate with other computing devices, such as web servers and external data servers (not shown). The I/O unit (204) can facilitate multiple communications within a wide variety of networks and protocol types, including wired networks, for example, LAN, cable, etc., and wireless networks, such as WLAN, cellular, or satellite. The I/O unit (204) may include one or more ports for connecting a number of devices to one another or to another server. In one embodiment, the I/O unit (204) allows the application server (101) to be logically coupled to other user computing devices (104), some of which may be built in. Illustrative components include tablets, mobile phones, wireless devices, etc.

Further, the input/output (I/O) unit (204) comprising input device namely keyboard, touchpad, trackpad may be configured to select one or more portions of the received input audio file by users to identify synthetic portion within the audio file. Further, the input/output (I/O) unit (204) may be configured to select a specific chunk from the one or more chunks by the user, via the UI. In an embodiment, the microphone may be configured to receive the selection from the user. Additionally, the system (100) may allow users to upload audio files from external storage devices or cloud services, enabling versatile methods for inputting audio for analysis.

Further, the user interface unit (205) may include the user interface (UI) displaying specific operations such as receiving selections corresponding to the user and presenting the classified input audio file to the user. The user interface unit (205) may feature the UI designed to facilitate interaction with the system (100) for audio analysis. In an exemplary embodiment, the UI may allow users to upload the input audio file for analysis. In an exemplary embodiment, the UI may allow users to select the one or more portions from the audio file for analysis. In another exemplary embodiment, the UI may allow the users to select a specific chunk from the one or more chunks to determine whether the selected chunk is real or synthetic. Users can interact with the UI through voice or text commands to initiate various operations, such as executing audio analysis tasks or adjusting parameters based on their preferences. In an exemplary embodiment, the UI may display current or intermediate status of the audio analysis process, and classified portion of the audio file to the user. Additionally, the user interface unit (205) may supports multiple content formats, including text, audio, and visual indicators, enabling users to provide input data seamlessly. This functionality allows the users to manage and modify audio analysis tasks in real-time, ensuring that their specific needs are met. Moreover, the user interface unit (205) may present relevant information, alerts, and notifications regarding the analysis outcomes and classifications, enhancing user engagement with the system. This addresses the limitations of conventional systems by accurately identifying synthetic portions within the received input audio file.

Further, the receiving unit (206) may be configured to receive the input audio file. In an exemplary embodiment, the receiving unit (206) may allow the system to receive audio files in various formats, such as WAV, MP3, or AAC. In an exemplary embodiment, the receiving unit (206) may verify the file format and size to ensure compatibility with the system's processing capabilities. Upon successful validation, the receiving unit (206) may transmit the audio file to the processor (201) for further analysis.

Further, the pre-processing unit (207) may be configured to pre-process (302) the received input audio file. In an embodiment, the pre-processing unit (207) may be configured to pre-process (302) the received input audio file for sampling the received input audio file based on a predefined sampling rate. The sampling of the received input audio file may be used to transform audio samples of the input audio file into a compatible sample rate of the system (100). In another embodiment, the pre-processing unit (207) may be configured for filtering the sampled input audio file in time domain to reduce either noise or artifacts in frequency domain, thereby preparing the audio file for further analysis.

In an exemplary embodiment, the pre-processing unit (207) receives the audio file containing background noise, such as a recording of a person speaking in a crowded cafe. For example, upon receiving the audio file, the pre-processing unit (207) may sample the audio to the predefined sampling rate of 16 kHz, optimizing it for further analysis. For example, the pre-processing unit (207) may apply a low-pass filter in the time domain to remove high-frequency noise, such as chatter and clinking dishes, ensuring that the primary speech signal remains clear. The resulting pre-processed audio file is then ready for further analysis.

In an exemplary embodiment, filtering of the sampled input audio file may be performed using one of hamming window, hanning window, low pass filter, high pass filter, band pass filter or a combination thereof.

In yet another embodiment, the pre-processing unit (207) may be configured to pre-process the received input audio file for identifying the one or more portions associated with one or more users, within the received input audio file.

In an exemplary embodiment, the user may select a portion of the audio file containing a female voice from an audio recording with both male and female voices, focusing on identifying synthetic audio specifically within the female voice section. Further, the pre-processing unit (207) is configured to pre-process the input audio file, isolating the selected portion including the female voice for further analysis. This ensures that only the relevant portion of the audio, as specified by the user, is analyzed for potential synthetic manipulations, improving accuracy and efficiency of the system (100).

Furthermore, the pre-processing unit (207) may be configured to split the pre-processed input audio file into the one or more chunks. In an embodiment, the splitting of the pre-processed input audio file into the one or more chunks may performed using a pre-defined time interval.

In an exemplary embodiment, after receiving the pre-processed input audio file, the audio may be segmented into the one or more chunks. For example, if the pre-processed audio file is 60 seconds long, the pre-processing unit (207) may be configured to divide the audio into four 15-second segments. This splitting allows for easier analysis of features corresponding to each chunk, enabling the system to process the audio in smaller, more focused segments.

In an embodiment, each chunk from the one or more chunks, obtained by the splitting, is partially overlap with an adjacent chunk of the one or more chunks.

In an exemplary embodiment, the splitting of the audio file into overlapping chunks may significantly enhance the capture of temporal features and contextual information. For example, consider a 3-second audio. If we split this audio into non-overlapping chunks, we would end up with segments like 0-1 seconds, 1-2 seconds, and 2-3 seconds. While this approach provides distinct segments, it may lead to a loss of information that occurs at the boundaries of each chunk. By introducing a 50% overlap, the chunks become 0-1 seconds, 0.5-1.5 seconds, 1-2 seconds, 1.5-2.5 seconds, and 2-3 seconds. This overlapping ensures that each chunk from the one or more chunks shares half of its data with adjacent chunks. This protects the one or more audio features that stretch across chunk boundaries and improves the accuracy of the system for analysis of the audio.

In another exemplary embodiment, when the audio is split into chunks in time domain, it may cause undesirable artifacts in frequency domain. To avoid this, the audio chunk may be processed by applying filters. For example, the filters such as hamming window, hanning window helps to protect the audio quality during processing.

In an embodiment, the receiving unit (206) may be configured to receive, a specific chunk from the one or more chunks to determine whether the selected chunk is real or synthetic. The specific chunk may be selected by user by the UI of the system (100).

In an exemplary embodiment, the receiving unit (206) may be configured to allow the user, via the UI, to select the specific chunk from the one or more chunks of the audio file. For example, the user might focus on a particular segment where they suspect manipulation, such as a suspiciously altered voice. The selected chunk is then analysed to determine whether it is real or synthetic, helping the user verify the authenticity of the selected chunk. The selection of a particular chunk from the one or more chunks and further analysis on the particular chunk only, leads to quick processing of the whole system (100) along with less computational processing and less storage, which overall optimize the functionality of the system (100) over the conventional systems.

Furthermore, the pre-processing unit (207) may be configured to extract the one or more features corresponding to each chunk from the one or more chunks. For example, each chunk may be individually examined for features such as pitch, background noise, and vocal content, facilitating more accurate classification in subsequent processing steps.

In an exemplary embodiment, the one or more features may include, but not limited to, one of a mel spectrogram, vocal tract model parameters, acoustic parameters, background noise, raw sample, pitch, frequency changes, file format or a combination thereof.

Furthermore, the embedding generation unit (208) may be configured to generate embeddings of each chunk from the one or more chunks, based on the extracted one or more features. In an embodiment, the embeddings generated by the transformer encoder model may be multi-dimensional vector representation of each chunk from the one or more chunks.

In an exemplary embodiment, embeddings may correspond to numerical vector representations of each chunk from the one or more chunks based on the extracted one or more features. These embeddings may be multi-dimensional vector representations of each chunk. For example, in case of an Audio Spectograph Transformer model, the encoder processes the input audio chunk and generates a 768-dimensional embedding that captures the essential features of the audio. This embedding compresses complex audio information into a vector format, which can be used by the system for further analysis, such as classifying whether the audio chunk is real or synthetic.

In an exemplary embodiment, transformer encoder model may correspond to one of Audio Spectrogram Transformer model, Whisper model, Wav2Vec2, EnCodec, Hubert (Hidden-Unit BERT), or a combination thereof.

In an embodiment, the embedding generation unit (208) may be configured to stack the extracted one or more features, before passing to a feeder neural network model, to create a volume of input to the feeder neural network model. Furthermore, the embedding generation unit (208) may be configured to input the extracted one or more features to the feeder neural network model based on the created volume of input, before passing to the transformer encoder model, for obtaining a changed activation volume of an input to the transformer encoder model.

In an exemplary embodiment, in case of the transformer encoder model, the feeder neural network may generate an activation volume that aligns with the specific input dimensions expected by the transformer encoder model. For example, if the input expected by the Audio Spectrogram Transformer model is structured as 16×128×128×1, where each of the 16 stacked spectrograms has a resolution of 128×128 with a single channel (audio intensity), the feeder neural network model is designed to produce an output activation volume that meets this requirement. Thus, the embedding generation unit (207) ensures that the output activation volume of the feeder neural network model matches the input dimensions expected by the transformer encoder model, enabling seamless data flow and ensuring effective training of both models.

In an exemplary embodiment, the feeder neural network model may correspond to one of convolutional neural network (CNN) layers, fully connected layers, sigmoid activation, ReLU (Rectified Linear Unit) activation, dropout layers, ResNet (Residual Networks), RawNet2, Deep Neural Network (DNN), or a combination thereof.

Furthermore, the classification unit (209) may be configured to classify each chunk from the one or more chunks, to either the real chunk or the synthetic chunk based on the generated embeddings.

In an embodiment, classification unit (209) may be configured to generate a classification score, for chunk from the one or more chunks. In an embodiment, the classification model may be configured to compare the classification score, of each chunk, with a predefined classification threshold to classify the chunk as the real chunk or the synthetic chunk. In an exemplary embodiment, the classification model may correspond to one of logistic regression, random forest, k-nearest neighbor (k-NN), support vector machines (SVM), or a combination thereof.

In an exemplary embodiment, the input audio chunk may first be processed by the transformer encoder model, which converts the input into an embedding, represented as the high-dimensional vector such as the 768-dimensional vector in case of the Audio Spectograph Transformer model. Furthermore, the classification unit (209) may be trained to transform these embeddings into a two-dimensional vector [a, b], where a=1−b. In an embodiment, the output “a” may represent the probability of the input audio chunk being classified as real, while “b” may represent the probability of the input audio chunk being classified as synthetic.

In an embodiment, the classification unit (209) may be configured to train the classification model using the one or more chunks of the input audio file. In an embodiment, during the training, the classification model may be configured to utilize one or more loss functions on the one or more chunks, to identify a wrong classification and further update the classification model using a back propagation technique. In an exemplary embodiment, the one or more loss functions may include a cross-entropy loss model, a triplet loss model, L2 regularizer, or a combination thereof.

In an exemplary embodiment, the training process is a standard procedure followed by neural network model to enhance system classification capabilities. For example, each input is fed into the classification model, which generates a score from a classification head, where an ideal score approaches 1 for fake chunks and near 0 for real chunks. If the model outputs an incorrect score such as predicting a value close to 0 for a fake chunk or vice versa, a loss function, such as cross-entropy loss or triplet loss, quantifies the discrepancy by assigning a high loss value for such erroneous predictions. This calculated loss is then utilized to update the model's parameters through a technique known as backpropagation. As a result, with each iteration of training, the model fine-tunes its parameters to improve its performance incrementally. This iterative learning process enables the model to accurately classify real and fake chunks.

In an exemplary embodiment, the classification between real and synthetic chunks is accomplished through the training of neural network model, designed specifically for classification. During training, the model learns to differentiate between real and fake chunks by utilizing an appropriate loss function, such as cross-entropy loss or triplet loss, which guides the optimization process. Upon completion of the training phase, the model generates embeddings including vector representations of the input data, ensuring that the embeddings of real chunks may be positioned distinctly apart from those of fake chunks. This thresholding may be performed via a smaller neural network referred to as the classification head. This classification head outputs the score between 0 and 1, representing the likelihood of the input being real or fake. In practice, a threshold of 0.5 is commonly employed, so if the score falls below 0.5, the input is classified as real chunk. Conversely, if the score exceeds 0.5, it is classified as fake chunk. This systematic approach enables differentiation between real and synthetic chunks, enhancing the overall accuracy of the classification process.

In an exemplary embodiment, the neural network model is often trained using a set of training data to classify inputs accurately. However, a common challenge arises when the model performs exceptionally well on this training data yet struggles to classify new, unseen data effectively. This concept is known as “overfitting,” where the model learns the noise and specific patterns of the training data instead of generalizing to new inputs. To mitigate overfitting, modifications may be made to the training objective, also referred to as the loss function. One effective method to prevent overfitting is the use of an L2 regularizer, which adds a penalty for larger weights in the model. By incorporating an L2 regularizer during training, the model is encouraged to develop a more generalized representation of the data, improving its performance on unseen data. As a result, a model trained with this regularization technique is better equipped to handle diverse inputs, enhancing its robustness and reliability in real-world applications.

Moreover, the application server (101) may be configured to provide each chunk from the one or more chunks with the indication of either the real chunk or the synthetic chunk, via the UI. In an embodiment, the indication may be provided to the user with the UI in different forms. In an exemplary embodiment, the indication of the real chunk and the fake chunk may be represented in the form of different colors assigned to chunks. For example, a fake chunk may be displayed as red color chunk and the real chunk may be represented as green color chunk.

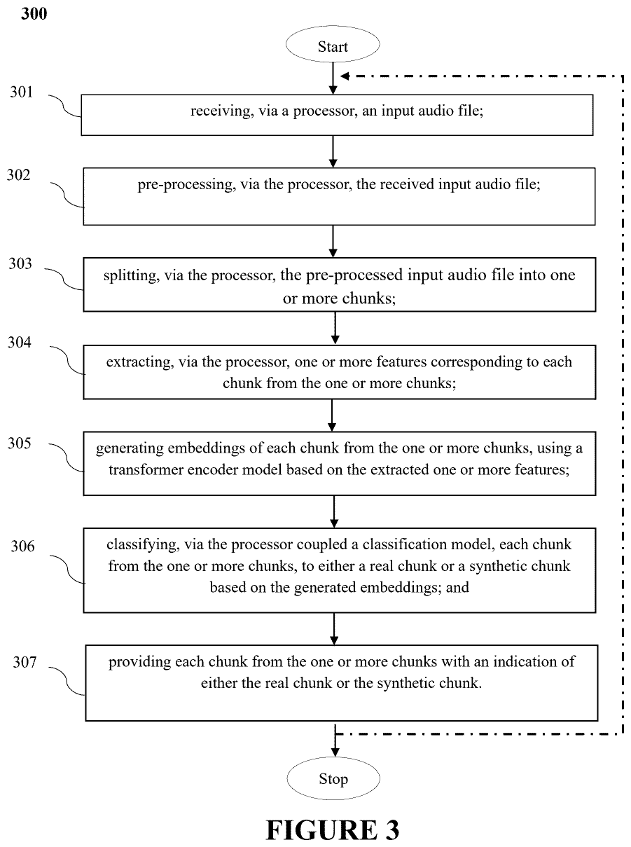

Now referring to FIG. 3, illustrates a flowchart describing a method (300) for the audio analysis, in accordance with at least one embodiment of the present disclosure. The flowchart is described in conjunction with FIG. 1 and FIG. 2. The method (300) starts at step (301) and proceeds to step (307).

In operation, the method (300) may involve a variety of steps for the audio analysis.

At step (301), the method (300) comprises a step of receiving the input audio file.

At step (302), the method (300) comprises a step of pre-processing the received input audio file.

At step (303), the method (300) comprises a step of splitting the pre-processed input audio file into the one or more chunks.

At step (304), the method (300) comprises a step of extracting the one or more features corresponding to each chunk from the one or more chunks.

At step (305), the method (300) comprises a step of generating embeddings of each chunk from the one or more chunks, using the transformer encoder model based on the extracted one or more features.

At step (306), the method (300) comprises a step of classifying, via the classification model, each chunk from the one or more chunks, to either the real chunk or the synthetic chunk based on the generated embeddings.

At step (307), the method (300) comprises a step of providing each chunk from the one or more chunks with the indication of either the real chunk or the synthetic chunk.

These sequence of steps may be repeated and continue till the system (100) stops receiving the input audio file.

Let us delve into a detailed example of the present disclosure.

### Working Example 1

Imagine an advanced audio analysis system designed to differentiate between real and synthetic audio chunks for applications such as content verification or fraud detection. A user uploads a 3-second audio clip of a conversation, which the system receives through its user interface. Upon receipt, the system automatically preprocesses the audio to remove noise and artifacts.

Next, the system splits the audio into overlapping chunks, such as 0-1 seconds, 0.5-1.5 seconds, 1-2 seconds, and so on. Each chunk is then processed to extract features like pitch, frequency, and background noise. The system inputs the extracted features into the feeder neural network model, which adjusts the activation volumes before passing them to the transformer encoder model, which then generates embeddings for each chunk. Additionally, the user can select specific chunks from the available options, allowing for more targeted analysis of relevant chunks within the audio.

The classification model then evaluates these embeddings to determine whether each chunk is real or synthetic, using a threshold of 0.5 for classification. If the model scores a chunk below 0.5, it classifies it as real, and if above, as synthetic.

The user receives a clear report indicating which chunks are authentic and which are potentially manipulated, providing valuable insights for content verification or quality assurance. This innovative approach enhances the system's ability to analyse audio files efficiently, ensuring high accuracy in distinguishing between real and artificial audio inputs.

### Working Example 2

Imagine an audio analysis system where the user uploads a 10-second audio containing speech and background music through the user interface (UI). The system preprocesses the audio by resampling it to 44.1 kHz and applying a Hamming filter to reduce frequency artifacts. The pre-processed audio is split into overlapping chunks of 1 second each with a 50% overlap, resulting in segments like 0-1 seconds and 0.5-1.5 seconds. Features such as mel spectrogram and pitch are extracted from these chunks and stacked to form a dataset. The feeder neural network model takes the extracted features as input, adjusts the activation volumes, and then passes them to the transformer encoder model to generate embeddings. These embeddings are classified using a support vector machine (SVM) to distinguish between real and synthetic chunks of the audio. Finally, the system presents the results to the user via the UI, indicating which chunks contain real speech and which are synthetic, providing valuable insights into the audio content.

In an exemplary embodiment, the system may identify the specific tool among various available AI tools, which created the detected synthetic audio or synthetic portion of the audio. This feature provides significant advantages in various applications, including law enforcement agencies, forensic analysis, content verification, and digital security. By pinpointing the exact AI tool used for generating synthetic audio, users can assess the reliability and potential motives behind the generated synthetic audio content.

A person skilled in the art will understand that the scope of the disclosure is not limited to scenarios based on the aforementioned factors and using the aforementioned techniques and that the examples provided do not limit the scope of the disclosure.

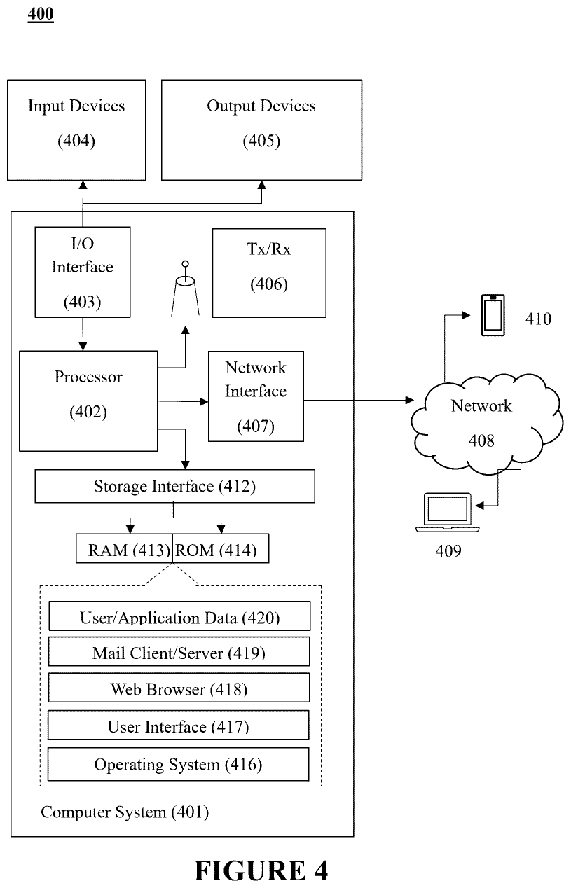

Now referring to FIG. 4, illustrates a block diagram (400) of an exemplary computer system (401) for implementing embodiments consistent with the present disclosure. Variations of computer system (401) may be used for audio analysis to identify synthetic portions within the audio. The computer system (401) may comprise a central processing unit (“CPU” or “processor”) (402). The processor (402) may comprise at least one data processor for executing program components for executing user-or system-generated requests. A user may include a person, a person using a device such as those included in this disclosure, or such a device itself. Additionally, the processor (402) may include specialized processing units such as integrated system (bus) controllers, memory management control units, floating point units, graphics processing units, digital signal processing units, or the like. In various implementations the processor (402) may include a microprocessor, such as AMD Athlon, Duron or Opteron, ARM's application, embedded or secure processors, IBM PowerPC, Intel's Core, Itanium, Xeon, Celeron or other line of processors, for example. Accordingly, the processor (402) may be implemented using mainframe, distributed processor, multi-core, parallel, grid, or other architectures. Some embodiments may utilize embedded technologies like application-specific integrated circuits (ASICs), digital signal processors (DSPs), or Field Programmable Gate Arrays (FPGAs), for example.

Processor (402) may be disposed of in communication with one or more input/output (I/O) devices via I/O interface (403). Accordingly, the I/O interface (403) may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMAX, or the like, for example.

Using the I/O interface (403), the computer system (401) may communicate with one or more I/O devices. For example, the input device (404) may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, or visors, for example. Likewise, an output device (405) may be a user's smartphone, tablet, cell phone, laptop, printer, fax machine, video display (e.g., cathode ray tube (CRT), liquid crystal display (LCD), light-emitting diode (LED), plasma, or the like), or audio speaker, for example. In some embodiments, a transceiver (406) may be disposed in connection with the processor (402). The transceiver (406) may facilitate various types of wireless transmission or reception. For example, the transceiver (406) may include an antenna operatively connected to a transceiver chip (example devices include the Texas Instruments® WiLink WL1283, Broadcom® BCM4750IUB8, Infineon Technologies® X-Gold 618-PMB9800, or the like), providing IEEE 802.11a/b/g/n, Bluetooth, FM, global positioning system (GPS), and/or 2G/3G/5G/6G HSDPA/HSUPA communications, for example.

In some embodiments, the processor (402) may be disposed in communication with a communication network (408) via a network interface (407). The network interface (407) is adapted to communicate with the communication network (408). The network interface, coupled to the processor may be configured to facilitate communication between the system and one or more external devices or networks. The network interface (407) may employ connection protocols including, without limitation, direct connect, Ethernet (e.g., twisted pair 10/100/1000 Base T), transmission control protocol/internet protocol (TCP/IP), token ring, or IEEE 802.11a/b/g/n/x, for example. The communication network (408) may include, without limitation, a direct interconnection, local area network (LAN), wide area network (WAN), wireless network (e.g., using Wireless Application Protocol), or the Internet, for example. Using the network interface (407) and the communication network (408), the computer system (401) may communicate with devices such as shown as a laptop (409) or a mobile/cellular phone (410). Other exemplary devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system (401) may itself embody one or more of these devices.

In some embodiments, the processor (402) may be disposed of in communication with one or more memory devices (e.g., RAM 413, ROM 414, etc.) via a storage interface (412). The storage interface (412) may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, or solid-state drives, for example.

The memory devices may store a collection of program or database components, including, without limitation, an operating system (416), user interface application (417), web browser (418), mail client/server (419), user/application data (420) (e.g., any data variables or data records discussed in this disclosure) for example. The operating system (416) may facilitate resource management and operation of the computer system (401). Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like.

The user interface (417) is for facilitating the display, execution, interaction, manipulation, or operation of program components through textual or graphical facilities. For example, user interfaces may provide computer interaction interface elements on a display system operatively connected to the computer system (401), such as cursors, icons, check boxes, menus, scrollers, windows, or widgets, for example. Graphical user interfaces (GUIs) may be employed, including, without limitation, Apple Macintosh operating systems' Aqua, IBM OS/2, Microsoft Windows (e.g., Aero, Metro, etc.), Unix X-Windows, or web interface libraries (e.g., ActiveX, Java, JavaScript, AJAX, HTML, Adobe Flash, etc.), for example.

In some embodiments, the computer system (401) may implement a web browser (418) stored program component. The web browser (418) may be a hypertext viewing application, such as Microsoft Internet Explorer, Google Chrome, Mozilla Firefox, Apple Safari, or Microsoft Edge, for example. Secure web browsing may be provided using HTTPS (secure hypertext transport protocol), secure sockets layer (SSL), Transport Layer Security (TLS), or the like. Web browsers may utilize facilities such as AJAX, DHTML, Adobe Flash, JavaScript, Java, or application programming interfaces (APIs), for example. In some embodiments the computer system (401) may implement a mail client/server (419) stored program component. The mail server (419) may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, or WebObjects, for example. The mail server (419) may utilize communication protocols such as internet message access protocol (IMAP), messaging application programming interface (MAPI), Microsoft Exchange, post office protocol (POP), simple mail transfer protocol (SMTP), or the like. In some embodiments, the computer system (401) may implement a mail client (420) stored program component. The mail client (520) may be a mail viewing application, such as Apple Mail, Microsoft Entourage, Microsoft Outlook, or Mozilla Thunderbird.

In some embodiments, the computer system (401) may store user/application data (421), such as the data, variables, records, or the like as described in this disclosure. Such databases may be implemented as fault-tolerant, relational, scalable, secure databases such as Oracle or Sybase, for example. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

Various embodiments of the disclosure provide a non-transitory computer readable medium and/or storage medium, and/or a non-transitory machine-readable medium and/or storage medium having stored thereon, a machine code and/or a computer program having at least one code section executable by a machine and/or a computer for audio analysis. The at least one code section in the application server (101) causes the machine and/or computer including one or more processors to perform the steps, which includes receiving (301) the input audio file. Further, the processor (201) may perform a step of pre-processing (302) the received input audio file. Furthermore, the processor (201) may perform a step of splitting (303) the pre-processed input audio file into the one or more chunks. Furthermore, the processor (201) may perform a step of extracting (304) the one or more features corresponding to each chunk from the one or more chunks. Furthermore, the processor (201) may perform a step of generating (305) embeddings of each chunk from the one or more chunks, using the transformer encoder model based on the extracted one or more features. Furthermore, the processor (201) may perform a step of classifying (306), via the classification model, each chunk from the one or more chunks, to either the real chunk or the synthetic chunk based on the generated embeddings. Additionally, the processor (201) may perform a step of providing (307) each chunk from the one or more chunks with the indication of either the real chunk or the synthetic chunk.

Various embodiments of the disclosure encompass numerous advantages including the system for audio analysis. The disclosed system and method have several technical advantages, but not limited to the following:
Improved Accuracy through Chunk-Based Analysis: By splitting the input audio file into smaller, manageable chunks, the system enables more precise detection of manipulated portions. This chunk-based analysis allows for the identification of synthetic portions that might otherwise be missed in conventional systems that treat audio as a whole.
Improved efficiency and scalability: The system reduces the time and computational resources required to analyse large audio files, making it more practical for real-time and resource-constrained applications.
User-driven customization: The system empowers users to select specific portions of the audio for analysis, allowing for more accurate and focused detection of synthetic audio within shorter periods.
Scalability for complex audio recordings: The system can handle larger, more complex audio files without sacrificing accuracy or increasing processing times, enabling better performance across a variety of applications, such as journalism, security, and public trust.
Advanced Transformer Encoder for Embedding Generation: The transformer encoder model generates embeddings from the modified features, enabling more sophisticated pattern recognition. This helps in identifying patterns specific to synthetic audio and enhances the system's capability to distinguish real from synthetic audio with higher precision.

In summary, these technical advantages solve the technical challenges associated with conventional audio analysis systems, including limited capabilities to process complex and entire audio recordings, increased memory and processing power, inefficiency in extracting relevant audio features, and lacking to identify subtle manipulations. By enabling users to select one or more portions of a whole audio, as well as the specific chunk from the one or more chunks, the system facilitates targeted analysis, significantly reducing computational load and processing time, thereby making real-time analysis more efficient and feasible. Furthermore, by employing advanced processing and classification techniques, the system enhances the accuracy in identifying synthetic portions within audio. This approach mitigates the risk of misclassification and improves overall reliability in distinguishing between real and artificial content.

The claimed invention of the system and the method for audio analysis involves tangible components, processes, and functionalities that interact to achieve specific technical outcomes. The system integrates various elements such as processors, memory, databases, and relevant units to analyse received input audio files by performing operations including pre-processing, splitting the pre-processed input audio file and extracting one or more features corresponding to each chunk from the one or more chunks. Further, the system utilizes the feeder neural network model, the transformer encoder model and classification model, to accurately identify real versus synthetic chunks in the input audio file.

Furthermore, the invention involves a non-trivial combination of technologies and methodologies that provide a technical solution for a technical problem. While individual components like processors, databases, encryption, authorization and authentication are well-known in the field of computer science, their integration into a comprehensive system for audio analysis, brings about an improvement and technical advancement in the field of digital media analysis by identifying synthetic portions in the audio. The scope of this application is limited to only analysis of audio data or audio files. In case of a digital media file contains visual and audio information, then the claimed steps of this application is limited to only analysis audio data of the media file.

In light of the above mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like. The claims can encompass embodiments for hardware and software, or a combination thereof.

While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure is not limited to the particular embodiment disclosed, but that the present disclosure will include all embodiments falling within the scope of the appended claims.

From the foregoing, it will be seen that this invention is one well adapted to attain all the ends and objects hereinabove set forth together with other advantages which are obvious, and which are inherent to the structure.

It will be understood that certain features and sub-combinations are of utility and may be employed without reference to other features or sub-combinations. This is contemplated by and is within the scope of the claims.

1. A system (100) for audio analysis, wherein the system (100) comprises:
a processor (201);
a memory (202) communicatively coupled with the processor (201), wherein the memory (202) is configured to store one or more executable instructions that, when executed by the processor (201), cause the processor (201) to:
receive (301) an input audio file;
pre-process (302) the received input audio file;
split (303) the pre-processed input audio file into one or more chunks;
extract (304) one or more features corresponding to each chunk from the one or more chunks;
generate (305) embeddings of each chunk from the one or more chunks, using a transformer encoder model based on the extracted one or more features;
classify (306), via a classification model, each chunk from the one or more chunks, to either a real chunk or a synthetic chunk based on the generated embeddings; and
provide (307), each chunk from the one or more chunks with an indication of either the real chunk or the synthetic chunk.

2. The system (100) as claimed in claim 1, wherein the processor (201) is configured to pre-process (302) the received input audio file for sampling the received input audio file based on a predefined sampling rate, wherein the processor is configured for filtering the sampled input audio file in time domain to reduce either noise or artifacts in frequency domain, wherein filtering of the resampled input audio file is performed using one of hamming window, hanning window, low pass filter, high pass filter, band pass filter or a combination thereof, wherein the processor is configured to pre-process the received input audio file for identifying one or more portions associated with one or more users, within the received input audio file.

3. The system (100) as claimed in claim 1, wherein the splitting (303) of the pre-processed input audio file into the one or more chunks is performed using a pre-defined time interval, wherein each chunk from the one or more chunks, obtained by the splitting (303), is partially overlapping with an adjacent chunk of the one or more chunks.

4. The system (100) as claimed in claim 1, wherein the one or more features comprises one of a mel spectrogram, vocal tract model parameters, acoustic parameters, background noise, raw sample, pitch, frequency changes, file format or a combination thereof.

5. The system (100) as claimed in claim 1, wherein the processor (201) is configured to stack the extracted one or more features, before passing to a feeder neural network model, to create a volume of input to the feeder neural network model; wherein the processor is configured to input the extracted one or more features to the feeder neural network model based on the created volume of input, before passing to the transformer encoder model, for obtaining a changed activation volume of an input to the transformer encoder model.

6. The system (100) as claimed in claim 1, the processor (201) is configured for training the classification model using the one or more chunks of the input audio file; wherein during the training, the processor (201) is configured to utilize one or more loss functions on the one or more chunks, to identify a wrong classification and further update the classification model using a back propagation technique; wherein the one or more loss functions comprise a cross-entropy loss model, a triplet loss model, L2 regularizer, or a combination thereof.

7. The system (100) as claimed in claim 5, wherein the feeder neural network model corresponds to at least one of a convolutional neural network (CNN) layers, fully connected layers, sigmoid activation, ReLU (Rectified Linear Unit) activation, dropout layers, ResNet (Residual Networks), RawNet2, Deep Neural Network (DNN), or a combination thereof.

8. The system (100) as claimed in claim 1, wherein the embeddings generated by the transformer encoder model are multi-dimensional vector representation of each chunk from the one or more chunks, wherein the transformer encoder model corresponds to one of Audio Spectrogram Transformer model, Whisper model, Wav2Vec2, EnCodec, Hubert (Hidden-Unit BERT), or a combination thereof.

9. The system (100) as claimed in claim 1, wherein the classification model is configured to generate a classification score, for each chunk from the one or more chunks, wherein the classification model is configured to compare the classification score, of each chunk, with a predefined classification threshold to classify the chunk as the real chunk or the synthetic chunk, wherein the classification model corresponds to one of logistic regression, random forest, k-nearest neighbor (k-NN), support vector machines (SVM), or a combination thereof.

10. The system (100) as claimed in claim 1, wherein the processor is configured to receive, a specific chunk from the one or more chunks to determine whether the selected chunk is real or synthetic, wherein the specific chunk is selected by a user.

11. A method (300) for audio analysis, the method (300) comprising:
receiving (301), via a processor (201), an input audio file;
pre-processing (302), via the processor (201), the received input audio file;
splitting (303), via the processor (201), the pre-processed input audio file into one or more chunks;
extracting (304), via the processor (201), one or more features corresponding to each chunk from the one or more chunks;
generating (305) embeddings of each chunk from the one or more chunks, using a transformer encoder model based on the extracted one or more features;
classifying (306), via the processor (201) coupled to a classification model, each chunk from the one or more chunks, to either a real chunk or a synthetic chunk based on the generated embeddings; and
providing (307) each chunk from the one or more chunks with an indication of either the real chunk or the synthetic chunk.

12. A non-transitory computer-readable storage medium having stored thereon, a set of computer-executable instructions that, when executed by a processor, cause the processor to perform steps comprising:
receiving (301) an input audio file;
pre-processing (302) the received input audio file;
splitting (303) the pre-processed input audio file into one or more chunks;
extracting (304) one or more features corresponding to each chunk from the one or more chunks;
generating (305) embeddings of each chunk from the one or more chunks, using a transformer encoder model based on the extracted one or more features;
classifying (306), via a classification model, each chunk from the one or more chunks, to either a real chunk or a synthetic chunk based on the generated embeddings; and
providing (307), each chunk from the one or more chunks with an indication of either the real chunk or the synthetic chunk.
